(19) United States
(12) Patent Application Publication
(10) Pub. No.: US 2025/0276863 A1
(43) Pub. Date: Sep. 4, 2025

(54) MATERIAL BIN APPARATUS AND ADHESIVE APPLICATION DEVICE

(71) Applicant: CONTEMPORARY AMPEREX TECHNOLOGY (HONG KONG) LIMITED, Hong Kong (CN)

(72) Inventor: Shiping QIU, Ningde (CN)

(21) Appl. No.: 19/209,485

(22) Filed: May 15, 2025

Related U.S. Application Data
(63) Continuation of application No. PCT/CN2023/136171, filed on Dec. 4, 2023.

(30) Foreign Application Priority Data
Oct. 8, 2023 (CN) 202311289703.6

(51) Int. Cl. B65H 1/14; B65H 1/28

(52) U.S. Cl. CPC B65H 1/14; B65H 1/28; B65H 2701/3772

(57) ABSTRACT

A material bin apparatus includes a base and a plurality of material bins. An accommodating space is formed in each material bins. The accommodating space is configured for stacking and storing a plurality of materials. The material bin includes a fixed member and a movable member. The fixed member is fixed to the base. The movable member is movably disposed on the base and defines the accommodating space with the fixed member. The movable members of at least some of the material bins can synchronously move away from or approach the fixed members.

### CROSS-REFERENCE TO RELATED APPLICATIONS

This application is a continuation of International Application No. PCT/CN2023/136171, filed on Dec. 4, 2023, which claims priority to Chinese Patent Application No. 202311289703.6, filed on Oct. 8, 2023 and entitled “MATERIAL BIN APPARATUS AND ADHESIVE APPLICATION DEVICE”, which are incorporated herein by reference in their entirety.

### TECHNICAL FIELD

This disclosure relates to the field of battery technologies, and specifically, to a material bin apparatus and an adhesive application device.

### BACKGROUND

The application of new energy batteries in both daily life and industry is becoming increasingly widespread. For example, new energy vehicles equipped with batteries have been widely used, and batteries are also increasingly applied in the field of energy storage, among others.

In the production of a battery pack, an automatic adhesive application machine can be used to attach a double-sided adhesive tape to a surface of a battery cell. During the production process, a material bin apparatus configured to store a double-sided adhesive tape cannot accommodate a variety of types of double-sided adhesive tapes, resulting in long tooling changeover times and reduced production efficiency.

### SUMMARY

To solve the above technical problems, this disclosure provides a material bin apparatus and an adhesive application device with good compatibility and high production efficiency. This disclosure is implemented through the following technical solutions.

According to a first aspect, this disclosure provides a material bin apparatus, the material bin apparatus including:
a base; and
a plurality of material bins, where an accommodating space is formed in each of the material bins, and the accommodating space is configured for stacking and storing a plurality of materials; and
the material bin includes a fixed member and a movable member, where the fixed member is fixed to the base; the movable member is movably disposed on the base and defines the accommodating space with the fixed member; and the movable members of at least some of the material bins can synchronously move away from or approach the fixed members.

Thus, the plurality of material bins can be configured to simultaneously feed, improving the feeding efficiency, thereby improving the production efficiency. Moreover, different types of materials (such as strip materials and plate materials) can be accommodated by adjusting a position of the movable member, thereby improving the compatibility of the material bin apparatus. In addition, the movable members of at least some of the material bins can synchronously move away from or approach the fixed members. That is, the movable members of the plurality of material bins can be simultaneously adjusted. This is conducive to achieving quick changeover, thereby improving the production efficiency.

In some embodiments, the material bin apparatus includes a plurality of material zones, each of the material zones includes a plurality of material bins, and each of the material zones has a feeding state and a preparation state.

The material bin apparatus is provided with the plurality of material zones. During the use of the material bin apparatus, when the material in the feeding state of the material zone is used up, the material zone in the feeding state is switched to the preparation state for material supplement, and the material zone in the preparation state is synchronously switched to the feeding state, thus allowing for feeding without shutdown and material change without shutdown, avoiding the problem of waiting for material change, and improving the processing efficiency.

In some embodiments, the base can rotate to switch each of the material zones between the feeding state and the preparation state.

That is, the base is controlled to rotate so as to switch each material zone between the feeding state and the preparation state. The structure for rotation of the base is simple, and a control method is simple and efficient.

In some embodiments, the material bin apparatus includes a turntable, the base is disposed on the turntable, and the turntable rotates to drive the base to rotate.

That is, the base is controlled to rotate so as to switch each material zone between the feeding state and the preparation state. The structure for rotation of the base is simple, and the control method is simple and efficient.

In some embodiments, the material bin apparatus includes a spacer disposed on the base; and two material zones are provided, and the two material zones are symmetrically disposed on two sides of the spacer.

The material bin apparatus includes a spacer disposed on the base. The spacer can be configured to separate different material zones. This is conducive to avoiding the influence between adjacent material zones to some extent, and ensuring the reliability of feeding and preparation in the material bin apparatus. In addition, the spacer can also be used as a positioning reference or for orientation, improving the convenience of using the material bin apparatus.

Two material zones are provided. Moreover, the two material zones are symmetrically disposed on two sides of the spacer. The spacer is configured to separate the two material zones, with one material zone being in use and the other in preparation. The provision of the spacer is conducive to avoiding the influence between feeding and preparation to some extent.

In some embodiments, the material bins of each of the material zones are arranged in a straight line. The movable member includes a first movable member. The material bin apparatus includes a drive mechanism, and the drive mechanism can be configured to synchronously drive first movable members of each of the material zones to reciprocate along a first direction.

Thus, the movement of all the first movable members of each material zone can be simultaneously controlled through the drive mechanism, so as to achieve the simultaneous changeover of all the material bins of each material zone, improving the changeover efficiency, and allowing for minute-level quick changeover, thereby improving the production efficiency.

In some embodiments, the movable member includes a second movable member. The drive mechanism can be configured to synchronously drive the second movable members of each of the material zones to reciprocate along a second direction, and the second direction intersecting the first direction.

Thus, the movement of all the second movable members of each material zone can be simultaneously controlled through the drive mechanism, so as to achieve the simultaneous changeover of all the material bins of each material zone, improving the changeover efficiency, and allowing for minute-level quick changeover, thereby improving the production efficiency.

In some embodiments, the first direction is an arrangement direction of each of the material bins in each of the material zones.

Thus, this is conducive to simultaneously controlling all the first movable members of each material zone to move along the first direction.

In some embodiments, the drive mechanism includes a first lead screw and a plurality of first nuts mating with the first lead screw; a first mounting groove and first sliding rail extending along the first direction are provided on the base; the first lead screw is rotatably disposed in the first mounting groove; the first nut is fixed to the bottom of each of the first movable members; the first lead screw rotates to drive each of the first nuts to reciprocate along the first direction; and each of the first nuts drives each of the first movable members to reciprocate along the first sliding rail.

One first lead screw is provided, each first movable member is connected and mated with the first lead screw through the first nut, thereby controlling the movement of all the first movable members of each material zone, achieving simultaneously changeover of all the material bins in each material zone, improving the changeover efficiency, and allowing for minute-level quick changeover, thereby improving the production efficiency. The structure of the drive mechanism is simple and reliable.

In some embodiments, the drive mechanism includes a second lead screw, a connecting member, and a second nut mating with the second lead screw; a second mounting groove and second sliding rail extending along the second direction are provided on the base; the second lead screw is rotatably disposed in the second mounting groove; the bottom of each of the second movable members and the second nut are both fixed on the connecting member; and the second lead screw rotates to drive the second nut to reciprocate along the second direction, so that the connecting member drives each of the second movable members to reciprocate along the second sliding rail.

One second lead screw is provided, and each second movable member is connected and mated with the second lead screw through the second nut and the connecting member, thereby controlling the movement of all the second movable members of each material zone, achieving simultaneously changeover of all the material bins in each material zone, improving the changeover efficiency, and allowing for minute-level quick changeover, thereby improving the production efficiency. The structure of the drive mechanism is simple and reliable.

In some embodiments, the fixed member includes a first fixed member and a second fixed member, the first fixed member is disposed relative to the first movable member, and the second fixed member is disposed relative to the second movable member.

The material bin includes the first fixed member, the second fixed member, the first movable member, and the second movable member. The double-sided adhesive tape can be limited through the first fixed member, the second fixed member, the first movable member, and the second movable member. The first fixed member is disposed relative to the first movable member, and the second fixed member is disposed relative to the second movable member. Thus, the dimensions of the accommodating space in the first direction and the second direction can be changed by moving the first movable member and the second movable member, so as to achieve changeover of the material bin.

In some embodiments, a moving distance of the first movable member along the first direction is L1, and 0 mm≤L1≤260 mm.

A variety of types of double-sided adhesive tapes can be accommodated by controlling the moving distance of the first movable member along the first direction to be L1, and a spacing between the material bins of a same material zone can be appropriate, allowing the structure of the material bin apparatus to be compact.

In some embodiments, the moving distance of the first movable member along the first direction is L1, and 25 mm≤L1≤140 mm.

Thus, a variety of types of double-sided adhesive tapes can be accommodated, and the spacing between the material bins of the same material zone can be appropriate, allowing the structure of the material bin apparatus to be more compact.

In some embodiments, a moving distance of the second movable member along the second direction is L2, and 10 mm≤L2<800 mm.

A variety of types of double-sided adhesive tapes can be accommodated by controlling the moving distance of the second movable member along the second direction to be L2, and the spacing between the material bins of the same material zone can be appropriate, allowing the structure of the material bin apparatus to be compact.

In some embodiments, the moving distance of the second movable member along the second direction is L2, and 130 mm≤L2≤305 mm.

Thus, a variety of types of double-sided adhesive tapes can be accommodated, and the spacing between the material bins of the same material zone can be appropriate, allowing the structure of the material bin apparatus to be more compact.

According to a second aspect, this disclosure provides an adhesive application device, and the adhesive application device includes the material bin apparatuses according to any one of the foregoing embodiments.

Thus, the plurality of material bins can be configured to simultaneously feed, improving the feeding efficiency, thereby improving the production efficiency. Moreover, different types of materials (such as strip materials and plate materials) can be accommodated by adjusting the position of the movable member, thereby improving the compatibility of the material bin apparatus. In addition, the movable members of at least some of the material bins can synchronously move away from or approach the fixed members. That is, the movable members of the plurality of material bins can be simultaneously adjusted. This is conducive to achieving quick changeover, thereby improving the production efficiency.

### BRIEF DESCRIPTION OF DRAWINGS

Persons of ordinary skill in the art will be clear about various other advantages and benefits by reading the detailed description of embodiments below. The accompanying drawings are only used to illustrate some embodiments and are not considered as a limitation of this disclosure. Moreover, in all the accompanying drawings, the same reference signs represent the same components. In the accompanying drawings:

FIG. 1 is a schematic structural diagram of a material bin apparatus from a first perspective according to some embodiments of this disclosure;

FIG. 2 is a schematic structural diagram of the material bin apparatus from a second perspective shown in FIG. 1;

FIG. 3 is a schematic structural diagram of the material bin apparatus from a third perspective shown in FIG. 1; and

FIG. 4 is a schematic structural diagram of the material bin apparatus from a fourth perspective shown in FIG. 1.

Reference signs are described as follows:
10, base; 10a, first mounting groove; 10b, first sliding rail; 10c, second mounting groove; 10d, second sliding rail; 20, material bin; 20a, accommodating space; 21, fixed member; 211, first fixed member; 212, second fixed member; 22, movable member; 221, first movable member; 222, second movable member; 30, turntable; 40, spacer; 50, drive mechanism; 51, first lead screw; 52, second lead screw; 53, connecting member; 100, material bin apparatus; and 100a, material zone.

### DESCRIPTION OF EMBODIMENTS

The following will describe the embodiments of the technical solutions of this disclosure in detail with reference to the accompanying drawings. The following embodiments are only used to more clearly illustrate the technical solutions of this disclosure, and are therefore only examples and cannot be used to limit the scope of protection of this disclosure.

Unless otherwise defined, all technical and scientific terms used herein shall have the same meanings as commonly understood by persons skilled in the art to which this disclosure relates. The terms used herein are intended to merely describe the specific embodiments rather than to limit this disclosure. The terms “include”, “comprise”, and “have” and any other variations thereof of this application are intended to cover non-exclusive inclusions.

In the description of the embodiments of this disclosure, the technical terms “first”, “second”, “third”, and the like are only used to distinguish different objects, and shall not be understood as any indication or implication of relative importance or any implicit indication of the number, specific sequence, or primary-secondary relationship of the technical features indicated. In the description of the embodiments of this disclosure, “a plurality of” means more than two, unless otherwise specifically defined.

In this specification, “embodiment” means that specific features, structures, or characteristics described with reference to the embodiment may be included in at least one embodiment of this disclosure. The term “embodiment” appearing in various places in the specification does not necessarily refer to the same embodiment or an independent or alternative embodiment that is exclusive of other embodiments. It is explicitly or implicitly understood by persons skilled in the art that the embodiments described herein may be combined with other embodiments.

In the description of the embodiments of this disclosure, the term “and/or” is only an associative relationship for describing associated objects, indicating that three relationships may be present. For example, A and/or B may indicate the following three cases: presence of only A, presence of both A and B, and presence of only B. In addition, a character “/” in this specification generally indicates an “or” relationship between contextually associated objects.

In the description of the embodiments of this disclosure, the technical terms “length”, “width”, “thickness”, “upper”, “lower”, “front”, “rear”, “left”, “right”, “vertical”, “horizontal”, “top”, “bottom”, “inner”, “outer”, “circumferential”, and the like indicate orientation or positional relationships based on the orientation or positional relationships shown in the accompanying drawings, and are only for the convenience of describing the embodiments of this disclosure and simplifying the description, and are not intended to indicate or imply that the referred device or element must have a specific orientation, be constructed, operated, or used in a specific orientation. Therefore, it should not be understood as a limitation on the embodiments of this disclosure.

In the description of the embodiments of this disclosure, unless otherwise specified and defined explicitly, the technical terms “mounting”, “connecting”, “joining”, “fixing” should be understood in their general senses. For example, they may refer to a fixed connection, a detachable connection, or an integral connection, may refer to a mechanical connection or electrical connection, and may refer to a direct connection, an indirect connection via an intermediate medium, an internal communication between two elements, or an interaction between two elements. Persons of ordinary skill in the art can understand specific meanings of the foregoing terms in the embodiments of this disclosure as appropriate to specific situations.

In the description of the embodiments of this disclosure, unless otherwise specified and defined explicitly, the technical term “contact” should be understood in a general sense, which can be direct contact or contact through an intermediate medium layer, can be contact with essentially no interaction force between the two contacting parties, or can be contact with interaction force between the two contacting parties.

The following provides a detailed description of this disclosure.

Currently, the application of new energy batteries in both daily life and industry is becoming increasingly widespread. New energy batteries have been widely used in energy storage power supply systems such as hydroelectric power plants, thermal power plants, wind power plants, and solar power plants, as well as many other fields including electric transportation tools such as electric bicycles, electric motorcycles, and electric vehicles, and aerospace.

In the embodiments of this disclosure, the battery can be a battery cell. A battery cell refers to a basic unit that can achieve mutual conversion between chemical energy and electrical energy, and can be configured to make battery modules or battery packs, thereby supplying power to electrical devices. The battery cell can be a secondary battery, and the secondary battery refers to a battery cell whose active material can be activated for continuous use through charging after the battery is discharged. The battery cell may be a lithium-ion battery, a sodium-ion battery, a sodium-lithium-ion battery, a lithium metal battery, a sodium metal battery, a lithium-sulfur battery, a magnesium-ion battery, a nickel-hydrogen battery, a nickel-cadmium battery, a lead storage battery, and the like. This is not limited in the embodiments of this disclosure.

In the embodiments of this disclosure, the battery can also be a battery module or battery pack including one or more battery cells.

In the production of the battery pack, an automatic adhesive application machine can be used to attach a double-sided adhesive tape to a surface of the battery cell. During the production process, a material bin apparatus configured to store a double-sided adhesive tape cannot accommodate a variety of types of double-sided adhesive tapes, resulting in long tooling changeover times and reduced production efficiency.

Based on the foregoing considerations, this disclosure designs a material bin apparatus and an adhesive application device, where the material bin apparatus includes a base and a plurality of material bins. The material bin is configured to include a fixed member and a movable member. The movable member is movably disposed on the base and define an accommodating space with the fixed member, where at least some of the movable members of the material bins can synchronously move away from or approach the fixed members. Thus, the plurality of material bins can be configured to simultaneously feed, improving the feeding efficiency, thereby improving the production efficiency. Moreover, different types of materials (such as strip materials and plate materials) can be accommodated by adjusting the position of the movable member, improving the compatibility of the material bin apparatus, thereby reducing the cost of the material bin apparatus. In addition, the movable members of at least some of the material bins can synchronously move away from or approach the fixed members. That is, the movable members of the plurality of material bins can be simultaneously adjusted. This is conducive to achieving quick changeover, thereby improving the production efficiency.

Embodiments of this disclosure provide an adhesive application device. The adhesive application device includes the material bin apparatus 100.

The material bin apparatus 100 is configured to store materials.

The specific type of the material is not limited herein, and the embodiments of this disclosure are described by taking an example in which the material is a double-sided adhesive tape.

The adhesive application device includes a film tearing device, and the film tearing device can be configured to tear away release paper from at least one side of the double-sided adhesive tape.

The adhesive application device includes a conveying system, and the conveying system can be configured to convey the double-sided adhesive tape to the film tearing device.

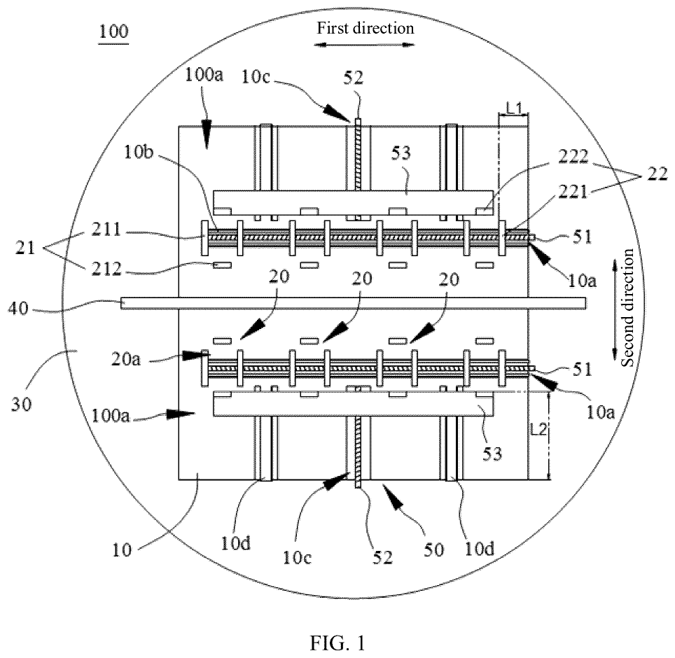

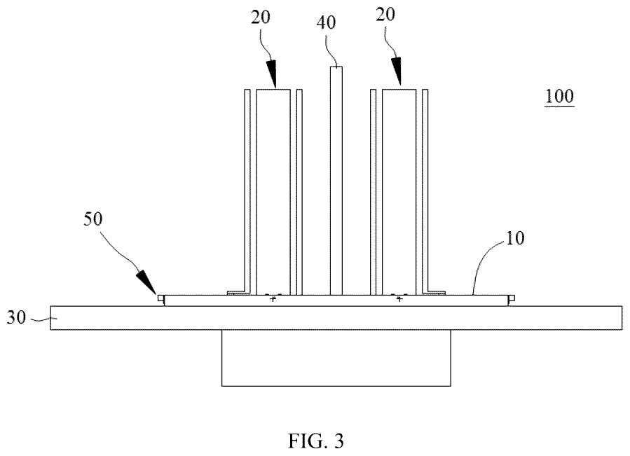

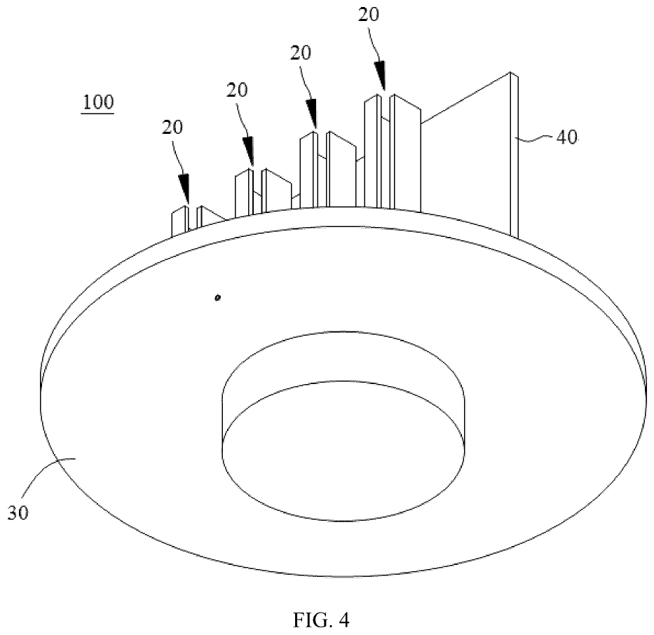

In some embodiments of this disclosure, referring to FIGS. 1 to 4, the material bin apparatus 100 includes a base 10 and a plurality of material bins 20. An accommodating space 20a is formed in each material bin 20, and the accommodating space 20a is configured for stacking and storing a plurality of materials. The material bin 20 includes a fixed member 21 and a movable member 22. The fixed member 21 is fixed to the base 10. The movable member 22 is movably disposed on the base 10 and defines the accommodating space 20a with the fixed member 21. The movable members 22 of at least some of the material bins 20 can synchronously move away from or approach the fixed members 21.

The accommodating space 20a is formed in each material bin 20, and the accommodating space 20a is configured for stacking and storing the plurality of materials. That is, the plurality of materials are stacked within the accommodating space 20a, and an opening is formed at an upper end of the accommodating space 20a, allowing the plurality of materials to be sequentially taken out from the opening at the upper end of the accommodating space 20a.

The material bin 20 includes the fixed member 21 and the movable member 22. The movable member 22 defines the accommodating space 20a with the fixed member 21.

The fixed member 21 is fixed to the base 10.

The specific method of fixing the fixed member 21 to the base 10 is not limited herein. For example, the fixed member 21 can be connected to the base 10 through snap-fit connection, fastening connection, plug-in connection, or the like.

The fastening connection includes but is not limited to screw connection, bolt connection, rivet connection, or the like.

The movable member 22 is movably disposed on the base 10 and defines the accommodating space 20a with the fixed member 21. That is, a distance between the movable member 22 and the fixed member 21 can be controlled by adjusting a position of the movable member 22, so as to accommodate different types of materials (such as strip materials and plate materials), thereby improving the compatibility of the material bin apparatus 100.

Thus, the fixed member 21 can be used as a reference standard. The movable member 22 moves to control the distance from the fixed member 21 and defines the accommodating space 20a with the fixed member 21, where the accommodating space 20a is suitable for different types of double-sided adhesive tapes.

The fixed member 21 and the movable member 22 extend along a height direction, allowing the movable member 22 and the fixed member 21 to define the accommodating space 20a extending along the height direction, thereby allowing the accommodating space 20a to stack and store the plurality of materials.

The movable members 22 of at least some of the material bins 20 can synchronously move away from or approach the fixed members 21. That is, the movable members 22 of the plurality of material bins 20 can synchronously approach or move away from the fixed members 21 by simultaneously adjusting the movable members 22, achieving quick and simultaneous adjustment of the plurality of material bins 20, thereby achieving quick changeover.

The material bin apparatus 100 provided by the embodiments of this disclosure includes the base 10 and the plurality of material bins 20. The material bin 20 includes the fixed member 21 and the movable member 22. The movable member 22 is movably disposed on the base 10 and defines the accommodating space 20a with the fixed member 21, where the movable members 22 of at least some of the material bins 20 can synchronously move away from or approach the fixed members 21. Thus, the plurality of material bins 20 can be simultaneously configured to feed, improving the feeding efficiency, thereby improving the production efficiency. Moreover, different types of materials (such as strip materials and plate materials) can be accommodated by adjusting the position of the movable member 22, improving the compatibility of the material bin apparatus 100, thereby reducing the cost of the material bin apparatus 100. In addition, the movable members 22 of at least some of the material bins 20 can synchronously move away from or approach the fixed members 21, that is, the movable members 22 of the plurality of material bins 20 can be simultaneously adjusted. This is conducive to achieving quick changeover, thereby improving the production efficiency.

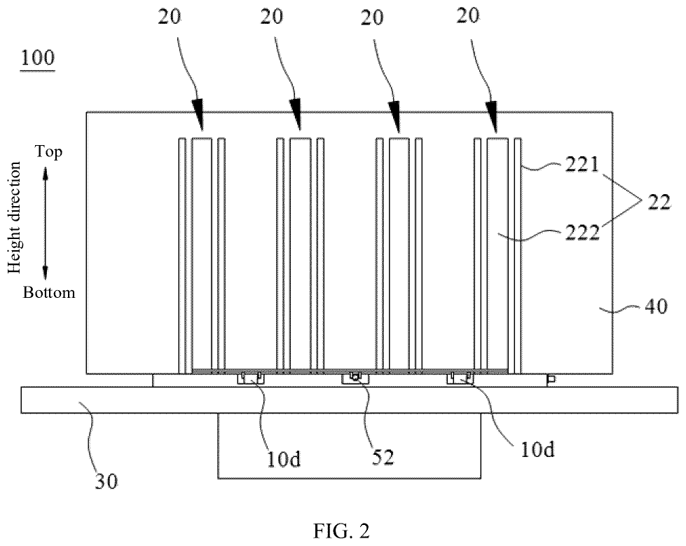

In some embodiments, referring to FIGS. 1 and 2, the material bin apparatus 100 includes a plurality of material zones 100a. Each material zone 100a includes the plurality of material bins 20, and each material zone 100a has a feeding state and a preparation state.

The material bin apparatus 100 includes the plurality of material zones 100a. The plurality of material zones 100a are provided. When one of the material zones 100a is subjected to feeding, the other material zones 100a can be configured for material preparation, thus allowing for feeding without shutdown and material change without shutdown, thereby improving the operating efficiency.

The plurality of material zones 100a are provided, so that manual material change can be performed on the material bins 20 of one material zone 100a, and the material bins 20 of the other material zones 100a can still operate normally, thus avoiding the problem of waiting for material change and improving the processing efficiency.

Each material zone 100a has the feeding state and the preparation state, where the feeding state of the material zone 100a refers to that the material zone 100a is not subjected to feeding, that is, the material zone 100a is in use. The preparation state of the material zone 100a refers to that the material zone 100a is subjected to feeding, that is, the material zone 100a is not in use, and the material zone 100a may be in the preparation state during material supplement or after material supplement.

The material bin apparatus 100 is provided with the plurality of material zones 100a. During the use of the material bin apparatus 100, when the material in the feeding state of the material zone 100a is used up, the material zone 100a in the feeding state is switched to the preparation state for material supplement, and the material zone 100a in the preparation state is synchronously switched to the feeding state, thus allowing for feeding without shutdown and material change without shutdown, avoiding the problem of waiting for material change, and improving the processing efficiency.

Referring to FIGS. 1 to 4, each material zone 100a includes the plurality of material bins 20, the plurality of material bins 20 can be simultaneously used for feeding, improving the feeding efficiency, thereby improving the production efficiency.

In a specific embodiment, referring to FIGS. 1 to 3, the material bin apparatus 100 includes two material zones 100a, with one material zone 100a being in use and the other in preparation, that is, during the use of the material bin apparatus 100, when one material zone 100a is in the feeding state, the other one is in the preparation state. When the material in the feeding state of the material zone 100a is used up, the material zone 100a in the feeding state is switched to the preparation state for material supplement, and the material zone 100a in the preparation state is synchronously switched to the feeding state, thus allowing for feeding without shutdown and material change without shutdown. The material bin apparatus 100 is provided with two material zones 100a, allowing for feeding without shutdown and material change without shutdown, and allowing the structure of the material bin apparatus 100 to be compact and have reduced space occupation.

Certainly, in other embodiments, the number of the material zones 100a in the material bin apparatus 100 may be three, four, five, or more.

It should be noted that the specific method of switching each material zone 100a between the feeding state and the preparation state is not limited herein.

In some embodiments, the base 10 can rotate to switch each material zone 100a between the feeding state and the preparation state. That is, the base 10 is controlled to rotate so as to switch each material zone 100a between the feeding state and the preparation state. The structure for rotation of the base 10 is simple, and a control method is simple and efficient.

It should be noted that a specific method for controlling the rotation of the base 10 is not limited herein.

In some embodiments, referring to FIGS. 1 to 4, the material bin apparatus 100 includes a turntable 30. The base 10 is disposed on the turntable 30. The turntable 30 rotates to drive the base 10 to rotate.

That is, turntable 30 is provided, and the base 10 is fixed to the turntable 30. The turntable 30 is rotated to drive such that the turntable 30 drives the base 10 to rotate. This method achieves the rotation of the base 10 without affecting the formation of the material bin 20 on the base 10, featuring a simple structure.

The specific method of deposing the base 10 on the turntable 30 is not limited herein. For example, the base 10 and the turntable 30 can be connected through magnetic connection, snap-fit connection, fastening connection, plug-in connection, or the like.

The specific shape of the turntable 30 is not limited herein and may be, for example, a circular shape, a polygonal shape, an elliptical shape, a track shape, an irregular shape, or the like.

The track shape refers to a shape similar to an athletic track and is formed by two semicircles and two parallel straight sides that are alternately connected.

The turntable 30 in the embodiments of this disclosure is circular. In a case of the same surface area, the circular turntable 30 requires the minimum rotation space, which can effectively save space, enabling the structure of the material bin apparatus 100 to be more compact.

The specific shape of the base 10 is not limited herein and may be, for example, a circular shape, a polygonal shape, an elliptical shape, a track shape, an irregular shape, or the like.

The base 10 in the embodiments of this disclosure is square. The square base 10 can fully utilize space to provide the material bin 20.

It should be noted that a specific method for controlling the rotation of the turntable 30 is not limited herein. For example, the rotation of the turntable 30 can be controlled by a servo motor.

In some other embodiments, the material bin apparatus 100 may alternatively not include the turntable 30, that is, the base 10 can be directly controlled to rotate, for example, the rotation of the base 10 can be controlled by the servo motor.

In some embodiments, referring to FIGS. 1 to 4, the material bin apparatus 100 includes a spacer 40 disposed on the base 10. Two material zones 100a are provided. Moreover, the two material zones 100a are symmetrically disposed on two sides of the spacer 40.

The material bin apparatus 100 includes the spacer 40 disposed on the base 10. The spacer 40 can be configured to separate different material zones 100a. This is conducive to avoiding the influence between adjacent material zones 100a to some extent, and ensuring the reliability of feeding and preparation in the material bin apparatus 100. In addition, the spacer 40 can also be used as a positioning reference or for orientation, improving the convenience of using the material bin apparatus 100.

Two material zones 100a are provided. Moreover, the two material zones 100a are symmetrically disposed on two sides of the spacer 40. The spacer 40 is configured to separate the two material zones 100a, with one material zone 100a being in use and the other in preparation. The provision of the spacer 40 is conducive to avoiding the influence between feeding and preparation to some extent.

In some other embodiments, when more than two material zones 100a are provided, a plurality of spacers 40 may alternatively be provided, and the plurality of material zones 100a are separated respectively.

In some embodiments, referring to FIGS. 1 to 4, the material bins 20 of each material zone 100a are arranged in a straight line. The movable member 22 includes a first movable member 221. The material bin apparatus 100 includes a drive mechanism 50. The drive mechanism 50 can be configured to synchronously drive first movable members 221 of each material zone 100a to reciprocate along a first direction.

The material bins 20 of each material zone 100a are arranged in a straight line. This is conducive to simultaneously controlling the quick movement of the material bins 20, thereby achieving quick changeover of the material bins 20 so as to be suitable for different types of double-sided adhesive tapes.

Certainly, in other embodiments, the material bins 20 can alternatively be arranged in a ring.

The number of the movable members 22 is not limited herein. For example, the movable member 22 includes the first movable member 221.

The specific type of the first movable member 221 is not limited herein. For example, the first movable member 221 is plate-shaped and extends along the height direction.

The material bin apparatus 100 includes the drive mechanism 50, and the drive mechanism 50 can be configured to drive the first movable member 221 to move.

The drive mechanism 50 can be configured to synchronously drive the first movable members 221 of each material zone 100a to reciprocate along the first direction. That is, the drive mechanism 50 can be configured to synchronously drive all the first movable members 221 of each material zone 100a to reciprocate along the first direction. Thus, the movement of all the first movable members 221 of each material zone 100a can be simultaneously controlled through the drive mechanism 50, so as to achieve the simultaneous changeover of all the material bins 20 of each material zone 100a, improving the changeover efficiency, and allowing for minute-level quick changeover, thereby improving the production efficiency.

It should be noted that the specific type of the first direction is not limited herein. For example, the first direction is an arrangement direction of the material bins 20 in each of the material zones 100a. Thus, this is conducive to simultaneously controlling all the first movable members 221 of each material zone 100a to move along the first direction.

Thus, this is conducive to controlling all the first movable members 221 of each material zone 100a.

In some embodiments, referring to FIG. 1, the movable member 22 includes a second movable member 222. The drive mechanism 50 can be configured to synchronously drive the second movable members 222 of each material zone 100a to reciprocate along a second direction. The second direction intersects the first direction.

The number of the movable members 22 is not limited herein. For example, the movable member 22 includes the second movable member 222.

The specific type of the second movable member 222 is not limited herein. For example, the second movable member 222 is plate-shaped and extends along the height direction.

The material bin apparatus 100 includes the drive mechanism 50, and the drive mechanism 50 can be configured to drive the second movable member 222 to move.

The drive mechanism 50 can be configured to synchronously drive the second movable members 222 of each material zone 100a to reciprocate along the second direction. That is, the drive mechanism 50 can be configured to synchronously drive all the second movable members 222 of each material zone 100a to reciprocate along the second direction. Thus, the movement of all the second movable members 222 of each material zone 100a can be simultaneously controlled through the drive mechanism 50, so as to achieve the simultaneous changeover of all the material bins 20 of each material zone 100a, improving the changeover efficiency, and allowing for minute-level quick changeover, thereby improving the production efficiency.

It should be noted that the specific type of the second direction is not limited herein. For example, the second direction intersects the first direction.

In a specific embodiment, the second direction is perpendicular to the first direction.

The movable member 22 includes the first movable member 221 and the second movable member 222. The drive mechanism 50 can synchronously drive all the first movable members 221 of each material zone 110a to reciprocate along the first direction and can synchronously drive the second movable members 222 of each material zone 100a to reciprocate along the second direction, so as to adjust the accommodating space 20a of the material bin 20 from a plurality of directions, further improving the compatibility of the material bin apparatus 100.

Certainly, in other embodiments, the number of the movable members 22 may alternatively be more than two.

It should be noted that the specific type of the drive mechanism 50 is not limited herein. For example, the drive mechanism 50 may be an electric cylinder, a screw mechanism, a motor sprocket structure, or the like.

In some embodiments, referring to FIGS. 1 to 3, the drive mechanism 50 includes a first lead screw 51 and a plurality of first nuts mating with the first lead screw 51. A first mounting groove 10a and first sliding rail 10b extending along the first direction are provided on the base 10. The first lead screw 51 is rotatably disposed in the first mounting groove 10a. The first nut is fixed to the bottom of each first movable member 221. The first lead screw 51 rotates to drive each first nut to reciprocate along the first direction. Each first nut drives each first movable member 221 to reciprocate along the first sliding rail 10b.

The drive mechanism 50 includes the first lead screw 51 and the plurality of first nuts mating with the first lead screw 51. That is, the drive mechanism 50 achieves transmission mainly through the mating of the first lead screw 51 and the first nuts.

The first mounting groove 10a and first sliding rail 10b extending along the first direction are provided on the base 10. The first lead screw 51 is rotatably disposed in the first mounting groove 10a. The first mounting groove 10a is configured to accommodate the first lead screw 51. The first sliding rail 10b is configured to stop the rotation of each first movable member 221 and to allow each first movable member 221 to move along an extension direction of the first sliding rail 10b.

Since the first mounting groove 10a and the first sliding rail 10b extend along the first direction, the first lead screw 51 also extends along the first direction.

The first nut is fixed to the bottom of each first movable member 221. The first lead screw 51 rotates to drive each first nut to reciprocate along the first direction. Each first nut drives each first movable member 221 to reciprocate along the first sliding rail 10b. Since the first nut is fixed to the first movable member 221, the first nut cannot rotate. Thus, when the first lead screw 51 rotates, the first nut can move along the first lead screw 51, thereby driving each first movable member 221 to move along the first lead screw 51.

That is, the first nut is fixed to the bottom of each first movable member 221, so that each first movable member 221 is rotatably connected to the first lead screw 51 through the first nut. When the first lead screw 51 rotates, the first nut can move along the first lead screw 51, thereby driving each first movable member 221 to move along the first lead screw 51, that is, driving each first movable member 221 to move along the extension direction of the first sliding rail 10b. One first lead screw 51 is provided, each first movable member 221 is connected and mated with the first lead screw 51 through the first nut, thereby controlling the movement of all the first movable members 221 of each material zone 100a, achieving simultaneously changeover of all the material bins 20 in each material zone 100a, improving the changeover efficiency, and allowing for minute-level quick changeover, thereby improving the production efficiency. The structure of the drive mechanism 50 is simple and reliable.

It should be noted that the rotation of the first lead screw 51 can be manually controlled or controlled by the servo motor, which is not limited herein.

The first lead screw 51 can extend beyond an end of the base 10, and an upper surface of the base 10 is higher than an upper surface of the turntable 30. This is conducive to manually rotating the first lead screw 51.

In some embodiments, referring to FIGS. 1 to 3, the drive mechanism 50 includes a second lead screw 52, a connecting member 53, and a second nut mating with the second lead screw 52. A second mounting groove 10c and second sliding rail 10d extending along the second direction are provided on the base 10. The second lead screw 52 is rotatably disposed in the second mounting groove 10c. The bottom of each second movable member 222 and the second nut are both fixed on the connecting member 53. The second lead screw 52 rotates to drive the second nut to reciprocate along the second direction. This allows the connecting member 53 to drive each second movable member 222 to reciprocate along the second sliding rail 10d.

The drive mechanism 50 includes the second lead screw 52, the connecting member 53, and the second nut mating with the second lead screw 52. That is, the drive mechanism 50 achieves transmission mainly through the mating of the second lead screw 52 and the second nut.

The second mounting groove 10c and second sliding rail 10d extending along the second direction are provided on the base 10. The second lead screw 52 is rotatably disposed in the second mounting groove 10c. The second mounting groove 10c is configured to accommodate the second lead screw 52. The second sliding rail 10d is configured to stop the rotation of each second movable member 222 and the connecting member 53, and to allow each second movable member 222 to move along an extension direction of the second sliding rail 10d.

Since the second mounting groove 10c and second sliding rail 10d extend along the second direction, the second lead screw 52 also extends along the second direction.

The bottom of each second movable member 222 and the second nut are both fixed on the connecting member 53. The second lead screw 52 rotates to drive each second nut to reciprocate along the first direction. The second lead screw 52 rotates to drive the second nut to reciprocate along the second direction. This allows the connecting member 53 to drive each second movable member 222 to reciprocate along the second sliding rail 10d. Since the second nut is fixed to the connecting member 53, and the second sliding rail 10d forms an anti-rotation coupling with the connecting member 53, the second nut cannot rotate. Therefore, when the second lead screw 52 rotates, the second nut can move along the second lead screw 52, so as to drive the connecting member 53 to move along the second lead screw 52, thereby allowing the connecting member 53 to drive each second movable member 222 to move along the second lead screw 52.

One second lead screw 52 is provided, and each second movable member 222 is connected and mated with the second lead screw 52 through the second nut and the connecting member 53, thereby controlling the movement of all the second movable members 222 of each material zone 100a, achieving simultaneously changeover of all the material bins 20 in each material zone 100a, improving the changeover efficiency, and allowing for minute-level quick changeover, thereby improving the production efficiency. The structure of the drive mechanism 50 is simple and reliable.

It should be noted that the rotation of the second lead screw 52 can be manually controlled or controlled by the servo motor, which is not limited herein.

In some embodiments, referring to FIG. 1, the fixed member 21 includes a first fixed member 211 and a second fixed member 212. The first fixed member 211 is disposed relative to the first movable member 221. The second fixed member 212 is disposed relative to the second movable member 222.

In the embodiments, the material bin 20 includes the first fixed member 211, the second fixed member 212, the first movable member 221, and the second movable member 222. The first fixed member 211, the second fixed member 212, the first movable member 221, and the second movable member 222 define the accommodating space 20a, that is, the double-sided adhesive tape can be limited through the first fixed member 211, the second fixed member 212, the first movable member 221, and the second movable member 222. The first fixed member 211 is disposed relative to the first movable member 221, and the second fixed member 212 is disposed relative to the second movable member 222. Thus, the dimensions of the accommodating space 20a in the first direction and the second direction can be changed by moving the first movable member 221 and the second movable member 222, so as to achieve changeover of the material bin 20.

In some embodiments, referring to FIG. 1, a moving distance of the first movable member 221 along the first direction is L1, and 0 mm<L1≤260 mm.

For example, at a temperature of 25° C., the moving distance L1 of the first movable member 221 along the first direction can be measured using a vernier caliper.

For example, the moving distance L1 of the first movable member 221 along the first direction can be 0.1 mm, 0.5 mm, 1 mm, 1.5 mm, 2 mm, 3 mm, 4 mm, 5 mm, 8 mm, 10 mm, 20 mm, 30 mm, 41 mm, 45 mm, 76 mm, 103 mm, 120 mm, 135 mm, 146 mm, 158 mm, 163 mm, 171 mm, 186 mm, 190 mm, 200 mm, 210 mm, 222 mm, 230 mm, 241 mm, 245 mm, 250 mm, 253 mm, 257 mm, 258 mm, or 260 mm.

The moving distance of the first movable member 221 along the first direction satisfies 0 mm<L1≤260 mm. That is, a variety of types of double-sided adhesive tapes can be accommodated by controlling the moving distance of the first movable member 221 along the first direction to be L1, and a spacing between the material bins 20 of a same material zone 100a can be appropriate, allowing the structure of the material bin apparatus 100 to be compact.

In some embodiments, referring to FIG. 1, the moving distance of the first movable member 221 along the first direction is L1, and 25 mm≤L1≤140 mm. Thus, a variety of types of double-sided adhesive tapes can be accommodated, and the spacing between the material bins 20 of the same material zone 100a can be appropriate, allowing the structure of the material bin apparatus 100 to be more compact.

In some embodiments, referring to FIG. 1, a moving distance of the second movable member 222 along the second direction is L2, and 10 mm≤L2≤800 mm.

For example, at a temperature of 25° C., the moving distance L2 of the second movable member 222 along the second direction can be measured using the vernier caliper.

For example, the moving distance L2 of the second movable member 222 along the second direction may be 10 mm, 20 mm, 30 mm, 80 mm, 103 mm, 120 mm, 135 mm, 146 mm, 158 mm, 200 mm, 210 mm, 222 mm, 230 mm, 241 mm, 245 mm, 250 mm, 300 mm, 330 mm, 385 mm, 400 mm, 463 mm, 496 mm, 500 mm, 535 mm, 576 mm, 600 mm, 620 mm, 645 mm, 682 mm, 700 mm, 741 mm, 775 mm, 790 mm, or 800 mm.

The moving distance of the second movable member 222 along the second direction satisfies 10 mm≤L2≤800 mm. That is, a variety of types of double-sided adhesive tapes can be accommodated by controlling the moving distance of the second movable member 222 along the second direction to be L2, and the spacing between the material bins 20 of the same material zone 100a can be appropriate, allowing the structure of the material bin apparatus 100 to be compact.

In some embodiments, referring to FIG. 1, the moving distance of the second movable member 222 along the second direction is L2, and 130 mm≤L2≤305 mm. Thus, a variety of types of double-sided adhesive tapes can be accommodated, and the spacing between the material bins 20 of the same material zone 100a can be appropriate, allowing the structure of the material bin apparatus 100 to be more compact.

In a specific embodiment, referring to FIGS. 1 to 4, the material bin apparatus 100 includes two material zones 100a and the spacer 40, with one material zone 100a being in use and the other in preparation and the material zones 100a symmetrically disposed about the spacer 40, that is, during the use of the material bin apparatus 100, when one material zone 100a is in the feeding state, the other one is in the preparation state. When the material in the feeding state of the material zone 100a is used up, the material zone 100a in the feeding state is switched to the preparation state for material supplement, and the material zone 100a in the preparation state is synchronously switched to the feeding state, thus allowing for feeding without shutdown and material change without shutdown. Each material zone 100a includes four material bins 20, and the four material bins 20 are arranged in a straight line along the first direction. The material bin apparatus 100 includes the turntable 30. The turntable 30 is provided, and the base 10 is fixed to the turntable 30. The turntable 30 is rotated to drive such that the turntable 30 drives the base 10 to rotate. The material bin 20 includes the first fixed member 211, the second fixed member 212, the first movable member 221, and the second movable member 222. The first fixed member 211, the second fixed member 212, the first movable member 221, and the second movable member 222 extend along the height direction and define the accommodating space 20a. An opening is formed at the upper end of the accommodating space 20a, allowing the plurality of materials to be sequentially taken out from the opening at the upper end of the accommodating space 20a. That is, the double-sided adhesive tape can be limited through the first fixed member 211, the second fixed member 212, the first movable member 221, and the second movable member 222. The first fixed member 211 is disposed relative to the first movable member 221, and the second fixed member 212 is disposed relative to the second movable member 222. Thus, the dimensions of the accommodating space 20a in the first direction and the second direction can be changed by moving the first movable member 221 and the second movable member 222, so as to achieve changeover of the material bin 20. The drive mechanism 50 includes the first lead screw 51 and the plurality of first nuts mating with the first lead screw 51. The first mounting groove 10a and first sliding rail 10b extending along the first direction are provided on the base 10. The first lead screw 51 is rotatably disposed in the first mounting groove 10a. The first nut is fixed to the bottom of each first movable member 221. The first lead screw 51 rotates to drive each first nut to reciprocate along the first direction. Each first nut drives each first movable member 221 to reciprocate along the first sliding rail 10b. The drive mechanism 50 includes the second lead screw 52, the connecting member 53, and the second nut mating with the second lead screw 52. The second mounting groove 10c and second sliding rail 10d extending along the second direction are provided on the base 10. The second lead screw 52 is rotatably disposed in the second mounting groove 10c. The bottom of each second movable member 222 and the second nut are both fixed on the connecting member 53. The second lead screw 52 rotates to drive the second nut to reciprocate along the second direction. This allows the connecting member 53 to drive each second movable member 222 to reciprocate along the second sliding rail 10d.

The accommodating space 20a is defined by the first fixed member 211, the second fixed member 212, the first movable member 221, and the second movable member 222 and is configured to place the double-sided adhesive tape required for a battery assembly process. Four first movable members 221 are adjusted to a maximum distance in the first direction by rotating the first lead screw 51; four second movable members 222 are adjusted to a maximum distance in the second direction by rotating the second lead screw 52; the double-sided adhesive tape is placed; the four first movable members 221 are adjusted to the positions closely contact with the double-sided adhesive tape in the first direction by rotating the first lead screw 51; the four second movable members 222 are adjusted to the positions closely contact with the double-sided adhesive tape in the second direction by rotating the second lead screw 52; and the feeding of the double-sided adhesive tape is completed. When the material in the feeding state of the material zone 100a is used up, the turntable 30 is provided, the material zone 100a in the feeding state is switched to the preparation state for material supplement, and the material zone 100a in the preparation state is synchronously switched to the feeding state, thus allowing for feeding without shutdown and material change without shutdown.

The foregoing embodiments are only used to illustrate the technical solutions of this disclosure and are not intended to limit it. Although this disclosure has been described in detail with reference to the foregoing embodiments, persons of ordinary skill in the art should understand that they may still make modifications to the technical solutions described in the foregoing embodiments or make equivalent replacements to some or all technical features thereof without departing from the scope of the technical solutions of the embodiments of this disclosure. They should all be covered in the scope of the claims and specification of this disclosure. In particular, as long as there is no structural conflict, the various technical features mentioned in the embodiments can be combined in any manner. This disclosure is not limited to the specific embodiments disclosed herein, but includes all technical solutions falling within the scope of this disclosure.

### Industrial Applicability

The material bin apparatus provided by the embodiments of this disclosure, the plurality of material bins are configured to simultaneously feed, improving the feeding efficiency, thereby improving the production efficiency. Moreover, different types of materials (such as strip materials and plate materials) can be accommodated by adjusting a position of the movable member, thereby improving the compatibility of the material bin apparatus. In addition, the movable members of the plurality of material bins can be simultaneously adjusted. This is conducive to achieving quick changeover, thereby improving the production efficiency.

What is claimed is:

1. A material bin apparatus, comprising:
a base; and
a plurality of material bins, wherein:
an accommodating space is formed in each of the material bins, and the accommodating space is configured for stacking and storing a plurality of materials;
each material bin comprises a fixed member and a movable member, wherein the fixed member is fixed to the base, and the movable member is movably disposed on the base and defines the accommodating space with the fixed member; and
the movable members of at least some of the material bins are able to synchronously move away from or approach the fixed members.

2. The material bin apparatus according to claim 1, wherein the material bin apparatus comprises a plurality of material zones, each of the material zones comprises a plurality of material bins, and each of the material zones has a feeding state and a preparation state.

3. The material bin apparatus according to claim 2, wherein the base is able to rotate to switch each of the material zones between the feeding state and the preparation state.

4. The material bin apparatus according to claim 3, further comprising:
a turntable;
wherein the base is disposed on the turntable, and the turntable rotates to drive the base to rotate.

5. The material bin apparatus according to claim 2, further comprising:
a spacer disposed on the base;
wherein two material zones are provided, and the two material zones are symmetrically disposed on two sides of the spacer.

6. The material bin apparatus according to claim 2, further comprising:
a drive mechanism;
wherein:
the material bins of each of the material zones are arranged in a straight line;
the movable member comprises a first movable member; and
the drive mechanism is able to be configured to synchronously drive the first movable members of each of the material zones to reciprocate along a first direction.

7. The material bin apparatus according to claim 6, wherein:
the movable member comprises a second movable member; and the drive mechanism is able to be configured to synchronously drive the second movable members of each of the material zones to reciprocate along a second direction, the second direction intersecting the first direction;
and/or the first direction is an arrangement direction of each of the material bins in each of the material zones.

8. The material bin apparatus according to claim 6, wherein the drive mechanism comprises a first lead screw and a plurality of first nuts mating with the first lead screw; a first mounting groove and first sliding rail extending along the first direction are provided on the base; the first lead screw is rotatably disposed in the first mounting groove; the first nut is fixed to the bottom of each of the first movable members; the first lead screw rotates to drive each of the first nuts to reciprocate along the first direction; and each of the first nuts drives each of the first movable members to reciprocate along the first sliding rail.

9. The material bin apparatus according to claim 7, wherein the drive mechanism comprises a second lead screw, a connecting member, and a second nut mating with the second lead screw; a second mounting groove and second sliding rail extending along the second direction are provided on the base; the second lead screw is rotatably disposed in the second mounting groove; the bottom of each of the second movable members and the second nut are both fixed on the connecting member; and the second lead screw rotates to drive the second nut to reciprocate along the second direction, so that the connecting member drives each of the second movable members to reciprocate along the second sliding rail.

10. The material bin apparatus according to claim 7, wherein the fixed member comprises a first fixed member and a second fixed member, the first fixed member is disposed relative to the first movable member, and the second fixed member is disposed relative to the second movable member.

11. The material bin apparatus according to claim 6, wherein a moving distance L1 of the first movable member along the first direction satisfies 0 mm≤L1≤260 mm.

12. The material bin apparatus according to claim 6, wherein a moving distance L1 of the first movable member along the first direction satisfies 25 mm≤L1≤140 mm.

13. The material bin apparatus according to claim 7, wherein a moving distance L2 of the second movable member along the second direction satisfies 10 mm≤L2≤800 mm.

14. The material bin apparatus according to claim 7, wherein a moving distance L2 of the second movable member along the second direction satisfies 130 mm≤L2≤305 mm.

15. An adhesive application device, comprising the material bin apparatus according to claim 1.
